(19) United States
(12) Patent Application Publication
(10) Pub. No.: US 2020/0171786 A1
(43) Pub. Date: Jun. 4, 2020

(54) FOAMED SHEET COMPRISING TPE AND THE PRODUCTS RESULTING THEREFROM AND THE PROCESS OF MAKING THE SAME

(71) Applicant: MuCell Extrusion, LLC, Woburn, MA (US)

(72) Inventors: Mehdi Saniei, Belmont, MA (US); Mark E. Lindenfelzer, Milton, MA (US); James K. Sakorafos, Shrewsbury, MA (US); Nicholas R. Torraco, Arlington, MA (US)

(73) Assignee: MuCell Extrusion, LLC, Woburn, MA (US)

(21) Appl. No.: 16/672,257

(22) Filed: Nov. 1, 2019

Related U.S. Application Data
(60) Provisional application No. 62/754,210, filed on Nov. 1, 2018.

(51) Int. Cl. B32B 5/18; B32B 5/14; B32B 27/08; C08J 5/18

(52) U.S. Cl. CPC B32B 5/18; B32B 5/142; B32B 27/08; C08J 5/18; B32B 2307/732; B32B 2307/5825; B32B 2377/00; B32B 2323/04; B32B 2323/10; B32B 2325/00; B32B 2327/06; B32B 2375/00; B32B 2307/718

(57) ABSTRACT

The present disclosure relates to a multilayer sheet comprising TPE (e.g., TPO) with at least one solid layer, and at least one foamed layer on the opposite side or one side of the solid layer. The web can be up to 3.2 meters wide with a gauge variation of less than 1%, and the average variation of the weight per unit area (gr/m²) of the sheet across the web is less than 2%. The foam sheet of the present invention can have an overal thickness of less than 50 mils with a bending stiffness value of less than 5, in Taber stiffness unit configuration according to TAPPI/ANSI T 489 om-15.

### RELATED APPLICATION

This application claims priority to U.S. provisional patent application No.: 62/754,210 filed on Nov. 1, 2018, which is incorporated herein by reference in its entirety.

### FIELD

This invention relates to a multilayer thermoplastic elastomeric foam sheet which maybe used for roofing and flooring applications.

### BACKGROUND

The present invention relates to a non-crosslinked foam sheet comprising a thermoplastic elastomeric (TPE) (e.g., thermoplastic olefinic (TPO)) foam. The physiomechanical properties and thickness uniformity of the sheet across the web is comparable, or even surpasses for few properties, to those of the equivalent solid counterpart. The product in this invention has the advantage to be used in a wide range of applications such as, but not limited to, recreational vehicle (RV) roofing and flooring, commercial roofing, indoor and outdoor flooring, indoor and outdoor paneling, geomembranes, water protection and preservation, floating baffles, bladder tank, advertising applications such as awning, and banners.

TPE products have captivated more attention compared to crosslinked rubbers such as SBR, NBR, EPDM, etc., due to the ease of processing and post-processing, recycling ability, non-toxicity, and being environmentally friendly. Multilayer TPE and rubber sheets are conventionally produced by bonding few monolayer sheets using bonding materials, adhesives or/and an intermediate fabric layer, and crosslinking agents. Accordingly, a multilayer foamed sheet can be fabricated using an intermediate bonding layer between a few foamed and solid sheets stacked together. However, the resulting products neither have a satisfactory adhesion between layers nor a narrow thickness variation, which influences the bending stiffness of the sheet. Also, the difficulties in the manufacturing process and the number of post-processing steps resulting in a costly product.

Patent application US 2009/0286893 disclosed a method to produce multilayer crosslinked TPE foam sheet comprises at least two foam sheets and/or a mesh layer, and TPE membrane for melt bonding wherein all layers should undergo a thermal compression step to be bonded together.

Patent application US 2016/0288455 disclosed a cross-linked multilayer TPE foam wherein the raw TPE materials containing at least a cross-linking agent and chemical blowing agent are mixed and heated up by a kneader until the mixture melts and mixes uniformly, then it is rolled into a sheet. The raw sheets are then stacked together and undergo a hot compression process during which the bonding and foaming happen together.

Welsh et al., in their patent U.S. Pat. No. 6,544,450 B2, disclosed the process of making a thermoplastic foam sheet with a uniform thickness by pulling and compressing the extrudate. The resulting foam sheet, however, may not necessarily have a uniform weight per unit area (g/m²), hence the uniform density across the web.

The objective of this invention is to fabricate a co-extruded wide multilayer TPE (e.g., a TPO) foam sheet, with the main focus, but not limited to, on RV roofing and flooring industry, with a physiomechanical properties comparable to the solid counterparts with a very stable geometry, e.g., gauge variation less than 4% across the web, very consistent base weight with a variation less than 4% across the web, and the bending stiffness in the order of that of the existing commercially available solid products. This invention discloses the solutions to put an end to the aforementioned difficulties in the processing, e.g., the thickness variation, and drawbacks in the similar methods explained in existing prior arts, e.g., heat compression process for bonding as well as cross-linking. One of our approaches in this invention was to produce a co-extruded multilayer TPE foam sheet with a foam layer in the core. Although the properties of the sheet were satisfactory for the market, the gauge variation, which still was less than that of the commercially available solid product, which is up to 10%, did not meet our expectations. Given the abovementioned difficulties and complexities, a more viable manufacturing approach to produce a multilayer TPE foam sheet needed to be developed. So, this invention discloses a multilayer TPE (e.g., a TPO) foam sheet comprises at least one foamed layer on the opposite side or one side of the solid layers.

### SUMMARY

The present invention relates to a multilayer sheet comprising TPE (e.g., TPO) with at least a solid layer, and at least one foamed layer on the opposite side or one side of the solid layer.

In one aspect, a coextruded non-crosslinked multilayer thermoplastic elastomeric foam sheet is provided. The sheet comprises at least one solid layer, and at least one thermoplastic elastomeric foamed layer on the opposite side or one side of the solid layer. The average gauge variation across the web of the sheet is less than 5% and/or the average variation of the weight per unit area (gr/m²) across the web of the sheet is less than 5%.

In one aspect, a coextruded non-crosslinked multilayer thermoplastic elastomeric foam sheet is provided. The sheet comprises at least one solid layer and at least one thermoplastic elastomeric foamed layer adjacent to the solid layer. The average gauge variation across the web of the sheet is less than 5% and/or the average variation of the weight per unit area (gr/m²) across the web of the sheet is less than 5%.

In some cases, a very small amount of physical blowing agents, for example, less than 1wt %, preferably an inert gas such as Nitrogen can be introduced at a very high injection pressure at supercritical state into the molten resin to form a single-phase polymer/blowing agent mixture.

In some embodiments, the resulting multilayer sheet can have an average thickness variation less than 1% across the web, a consistent base wight with an average variation less than 2% across the web, a Taber bending stiffness, according to TAPPI/ANSI T 489 om-15, less than 5, and elongation at break, according to ASTM D412, greater than 900%.

In some embodiments, the foam structure of the skin layers can comprise cells with an average cell size of 10-100 μm, and the cell density in the range of 10²-10⁹ cells/cm³. Since no post-processing step, such as bonding the separate layers explained in the above-mentioned conventional method, might be needed in the process of this invention, there is no discontinuity between the layers, which can result in peeling between the layers.

### DETAILED DESCRIPTION

The singular forms “a,” “an,” and “the” include plural referents unless the context clearly dictates otherwise.

As used in the specification and in the claims, the term “comprising” may include the embodiment “consisting of” and “consisting essentially of.”

All ranges disclosed herein are inclusive of the recited endpoint and independently combinable (for example, the range of from 2 grams to 10 grams” is inclusive of the endpoints, 2 grams and 10 grams, and all the intermediate values)

As used herein, approximating language may be applied to modify any quantitative representation that may vary without resulting in a change in the basic function to which it is related. Accordingly, a value modified by a term or terms, such as “about” and “substantially,” may not be limited to the precise value specified. The modifier “about” should also be considered as disclosing the range defined by the absolute value of the two endpoints. For example, the expression “from about 2 to about 4” also discloses the range “from 2 to 4”.

The term “foam” refers to a cellular structure formed when a gas is blown into the molten polymer, and bubbles nucleate when the gas diffuses out of the polymer, right after the application of a thermodynamic instability, as the polymer solidifies.

The term “web” refers to the width of the coextruded sheet which is measured in the transverse direction, or the lay flat when an annular die is used.

The present disclosure relates to a multilayer TPE (e.g., TPO) foam sheet which can be used in a wide range of applications such as, but not limited to, recreational vehicle roofing, commercial roofing, indoor and outdoor flooring, indoor and outdoor paneling, geomembranes, water protection, water preservation, covers/floors for tanks and ponds, floating baffles, baffle curtains for underground reservoir, secondary containment, bladder tank, advertising applications such as awning, banners.

Conventionally, thick multilayer TPE and rubber sheets comprise a thin intermediate layer, for example, a fabric or adhesive layer, for bonding or reinforcing purposes. The resulting products, however, neither have a satisfactory adhesion between layers nor a narrow thickness variation, which can influence the bending stiffness of the sheet. Also, the difficulties in the manufacturing process and the number of post-processing steps resulting in a costly product. The multilayer sheet described herein is produced using a coextrusion line wherein different layers can be bonded together inside the die, for example flat sheet die, when they are molten. So, there is no need for using intermediate adhesive or bonding layers between the core layer and other layers. The flat extrudate then passes through cold rolls to be solidified which can further help to maintain a uniform thickness across the web. Moreover, one or both sides of the sheet can be textured, embossed or engraved, while passing through the cold rolls.

In the production of a coextruded multilayer sheet using a flat die, typically the most challenging issues other than avoiding wrinkles and corrugation, which even becomes more pronounced and severe when foaming happens resulting in higher volume output, is having a uniform thickness as well as a consistent sheet density profile across the web. It is very difficult to spread the melt uniformly through the inner layers, e.g., core layer specifically when using a very wide sheet die (e.g., 3 meters wide). Regardless of the possibility of taking advantage of a multi-manifold sheet die, compared to using a combining block or co-ex block, which can improve the thickness uniformity of each layer, it is crucial to control and match the viscosity of the melt in each layer.

The present disclosure relates to a coextruded non-crosslinked multilayer TPE (e.g., TPO) foam sheet, which could be produced with a physical blowing agent, comprising at least one solid layer, and at least one foamed layer on the opposite side or one side of the solid layer/layers. In another embodiment, a coextruded non-crosslinked multilayer thermoplastic elastomeric foam sheet comprising at least one solid layer and at least one thermoplastic elastomeric foamed layer, wherein at least one foamed layer is adjacent to the solid layer. There might be no need to include an intermediate layer (e.g., intermediate adhesive layer) for bonding of the adjacent layers.

In one embodiment, the product described herein comprises at least one foam layer between the skin layers. In another embodiment, either of the skin layers has an expansion ratio of about 1 to 1.2.

The blowing agent used to make the foam layer/layers can be either Nitrogen, Carbon Dioxide, or the mixture of Nitrogen and Carbon Dioxide. In some cases, any kind of chemical blowing agent might be an option to be used as a foaming agent. A very small and precise amount of above mentioned supercritical gases as a processing aid and blowing agent, for example, less than 1 wt %, could be injected into the molten polymer at a high pressure, for example, greater than 34 bar, in some cases greater than 73.8 bar, in some cases greater than 240 bar, and in some cases greater than 380 bar inside an efficient and effectual mixer, e.g. the cavity transfer mixer, as an extension to the extruder's barrel. The temperature of the mixer could be controlled accurately within ±1° C. The inclusion of a very small amount of gas, which alters the viscosity of the polymer, as well as accurately controlling the temperature of the mixing zone could offer the possibility to match the viscosity of the melt in different layers. This could enable us to spread the melt uniformly across the web in the core and the skin, which in turn may result in consistent layer thickness. The multilayer foam sheet of the products described herein can be produced at least 0.5 meters wide, in some cases at least 1.5 meters wide, in some cases at least 2 meters wide, and in some cases at least 2.5 meters wide.

The multilayer coextruded foam sheet described herein can have at least one layer comprises any of the resins in TPE family such as, but not limited to, propylene-ethylene copolymer, Styrene-Ethylene-Butadiene-Styrene (SEBS), Styrene-Butadiene-Styrene (SBS), Styrene-[ethylene-(ethylene-propylene)]-Styrene block copolymer (SEEPS), Styrene-isoprene block copolymers (SIS), Thermoplastic Olefin (TPO), Thermoplastic Polyurethane (TPU), Melt Processible Rubbers (MPR), Co-polyester-Ether (COPE), Polyether Block Amide (PEBA).

The multilayer coextruded foam sheet described herein can have at least one layer comprises any thermoplastic resins such as, but not limited to, polyethylene (PE), polypropylene (PP), polystyrene (PS), ethylene vinyl acetate (EVA), ethylene vinyl alcohol (EVOH), polyvinyl chloride (PVC), Polyvinylidene chloride (PVDC), polyamide (PA), polyurethane (PU), or Maleic anhydride, or an ionomer.

In some embodiments, at least one layer of the multilayer foam sheets products described herein comprises less than 50% by weight polypropylene, in some cases less than 30 wt % PP, in some cases, less than 20 wt % PP, and in some cases, less than 10 wt % PP.

In some other embodiments, the products described herein might have apt amounts of color pigments in either or both of the skin layers.

All the multilayer foam sheets described herein, which can have a thickness from 10 mils to 400 mils, in some embodiments more than 400 mils, has sets of improved physiomechanical and geometrical properties compared to the articles in pre-existing arts, to the best of applicant's knowledge, as the average thickness variation across the web can be less than 1%, and the average variation of the weight per unit area (gr/cm²) across the web can be less than 2%. In one embodiment, it is possible to make the product described herein with a thickness of less than 10 mils.

In some embodiments, the described multilayer foam sheet can have an average gauge variation across the web less than 5%, in some cases less than 3%, and in some cases less than 1%. Also, in some embodimets, the average variation of the weight per unit area (gr/m²) of the sheet across the web can be less than 5%, in some embodiments less than 3%, and in some other embodiments less than 1%.

In some embodiments, the Taber bending stiffness, according to TAPPI/ANSI T 489 om-15, of the products described herein can be less than 100, in some cases less than 50, in some cases, less than 20, and in some other cases less than 10; among which the sheets with a thickness less than 100 mils can have a Taber bending stiffness of less than 10, in some embodiments less than 5, in some embodiments, less than 2, and in some other embodiments less than 1.

The multilayer foam sheet in this invention can have mechanical properties comparable to, or even in some case surpasses, that of the solid non-foamed counterpart. In some cases, the elongation at break of the products described herein can be greater than 100%. In some embodiments, the elongation at break of the foam sheet can be greater than 900%.

The cellular morphology of the foamed layer could be controlled by adding a 0.05 wt % to 15 wt % nucleating agent, which might be any organic or inorganic additives, that could enable us to have heterogeneous cell nucleation in the presence of the dissolved physical blowing agent. In one embodiment, at least one layer of the multi-layer sheet described herein comprises nucleating/clarifying agents with content less than 1% by weight. The structure of the foamed skin can comprise the uniformly dispersed cells with an average cell size of 10-1000 μm, the average cell density of 10²-10⁹ cells/cm³, and the expansion ratio from 1 to 9. For example, the foam product can have 5% to 45% density reduction, compared to the solid counterparts. In another embodiment, the foam sheets might have more than 45% density reduction compared to the non-foamed sheet. All the equipment used in this invention are conventional polymer processing equipment, very well-known to the skilled persons in the art and well labeled and extensively described in the literature.

In some cases, the multilayer coextruded products in this invention can be produced using an annular die, in the blown film process, or any other methods known in the art.

In another embodiment, a coextruded multilayer sheet comprises a cellular structure in the core with solid and/or foamed layers on the opposite side of the core layer can be among the product of this invention.

The following examples demonstrate the process of the present disclosure. The examples are only demonstrative and are intended to put no limit on the disclosure with regards to the materials, conditions, applications, dimensions, or the processing parameters set forth herein.

### EXAMPLES

The sheet in this example includes three layers was produced on a coextrusion line comprising one 6.5 inch main extruder and one 4.5 inch co-extruder both of which are from Davis-Standard were equipped with a supercritical gas injection unit capable of injecting N₂ and/or CO₂ as well as MuCell Transfer Mixer (MTM), both from MuCell Extrusion LLC, and a 120 inch wide flat sheet die.

All samples in this example were produced with an ethylene-propylene copolymer which also was blended with 20 wt % impact modifier for the core layer. All layers were also included with 5.6 wt % anti-UV additives. Supercritical Nitrogen was used as a physical blowing agent and was injected into the MuCell Transfer Mixer (MTM) at the concentration from 0.020% to 0.06%, very accurately. The solid sample as well as sample #13, wherein the core layer is foamed, are provided for comparison.

To characterize the tensile strength, elongation (according to ASTM D412), puncture strength (according to ASTM F1306), and tear strength (according to ASTM D624) of the sheet a universal testing machine from Tenious Olsen equipped with proper pneumatic grippers and two load cells in the range of 1000 (N) and 10(KN) was used. To characterize the bending stiffness of the sheet, a TABER Stiffness Tester Model 150-E from Taber Industries was used. The bending stiffness of the samples was mesured in Taber stiffness unit configuration according to TAPPI/ANSI T 489 om-15.

All the demonstrated samples, which are listed in the following table, comprise three layers. Sample #SOLID is the solid counterpart of the samples #10, #12, and #13. Sample #13 has a foam layer in the core versus sample #10, and #12 comprises a solid core and two foam layers on the opposite side of the solid core layer. The gauge variation across the web has been improved to less than the average 0.7% for sample #12 compared to sample #13 which has a foam layer in the core.

Similarly, in sample #12 the average specific weight variation (gr/cm²) has decreased to less than 2%. More importantly, the Taber bending stiffness in sample #12 has declined to less than 1% compared to the Solid sample as well as sample #13.

The bending stiffness, in Taber unit configuration, of sample #12 decreased dramatically to below 1 probably due to the inclusion of the foamed skin layers on the opposite side of the solid core layer. The elongation at break for the sample #12 improved and surpassed that of the solid counterpart.

| | Sample | | | |
|---|---|---|---|---|
| | C1-12-SOLID | C1-12-10 | C1-12-12 | C1-12-13 |
| | (#SOLID) | (#10) | (#12) | (#13) |
| Density (gr/cm³) | 0.896 | 0.79 | 0.726 | 0.714 |
| Thickness (mils) | 29.7 | 29 | 29 | 31 |
| Avg. Gauge variation (%) | 3.5% | 0.9% | 0.7% | 3.5% |
| Specific weight (gr/m²) | 608 | 575.8 | 534.7 | 544 |
| Avg. Specific weight variation (%) | 1.62% | 1.15% | 1.72% | 3.6% |
| Ext. A Throughput (kg/hr) | 345 | 246 | 285 | 241 |
| Ext. B Throughput (kg/hr) | 288 | 288 | 241 | 285 |
| Ext. A PBA % | 0 | 0.039 | 0.061 | 0 |
| Ext. B PBA % | 0 | 0 | 0 | 0.06 |
| Line speed (m/min) | 4.44 | 5.19 | 5.64 | 5.49 |
| Ext. A MTM Melt Temp (° C.) | 188 | 188 | 180 | 188 |
| Ext. B MTM Melt Temp (° C.) | 188 | 188 | 188 | 180 |
| Tensile Strength at Break (MPa) | 10.21 | 7.6 | 9.6 | 8.58 |
| Elongation at Break (%) | 830 | 752 | 890 | 813 |
| Yield Stress (MPa) | 2.6 | 2.1 | 2.5 | 2.51 |
| Tear Strength (kN/m) | 46.52 | 42.50 | 38.65 | 39.39 |
| Tensile Stress at 100% (MPa) | 2.71 | 2.4 | 2.55 | 2.58 |
| Tensile Stress at 300% (MPa) | 3.17 | 2.93 | 3.02 | 3.03 |
| Taber bending stiffness | 6.04 | 1.4 | 0.75 | 4.6 |
| Max Puncture Force (N) | 43.9 | 26 | 31.7 | 32 |
| Energy to Break (mJ) | 526 | 238 | 358 | 338 |

What is claimed is:

1. A coextruded non-crosslinked multilayer thermoplastic elastomeric foam sheet comprising at least one solid layer, and at least one thermoplastic elastomeric foamed layer on the opposite side or one side of the solid layer, wherein the average gauge variation across the web of the sheet is less than 5% and/or the average variation of the weight per unit area (gr/m²) across the web of the sheet is less than 5%.

2. A coextruded non-crosslinked multilayer thermoplastic elastomeric foam sheet comprising at least one solid layer and at least one thermoplastic elastomeric foamed layer, wherein at least one foamed layer is adjacent to the solid layer, and the average gauge variation across the web of the sheet is less than 5% and/or the average variation of the weight per unit area (gr/m²) across the web of the sheet is less than 5%.

3. The sheet of claim 1, wherein the web of the sheet is about 0.5 to 3.2 meters wide.

4. The film of claim 1, wherein no adhesive layer is used between the adjacent layers.

5. The sheet of claim 1, wherein the average guage variation across the web of the sheet is less than 3%.

6. The sheet of claim 1, wherein the average variation of the weight per unit area (gr/m²) of the sheet across the web is less than 3%.

7. The sheet of claim 1, wherein the thickness of the sheet is less than 100 mils.

8. The sheet of claim 1, wherein the bending stiffness value of the sheet is less than 20 in Taber stiffness unit configuration according to TAPPI/ANSI T 489 om-15.

9. The sheet of claim 1, wherein the thickness of the sheet is less than 50 mils.

10. The sheet of claim 1, wherein the bending stiffness value of the sheet is less than 5 in Taber stiffness unit configuration according to TAPPI/ANSI T 489 om-15.

11. The sheet of claim 1, wherein the sheet has a tear strength greater than 38 kN/m, according to ASTM D624.

12. The sheet of claim 1, wherein the sheet has a maximum puncture force greater than 30 (N), according to ASTM F1306.

13. The sheet of claim 1, wherein the elongation at break is greater than 100%.

14. The sheet of claim 1, wherein the elongation at break is greater than 500%.

15. The sheet of claim 1, wherein the thickness of the sheet is more than 50 mils.

16. The sheet of claim 1, wherein the bending stiffness value of the sheet is less than 100 in Taber stiffness unit configuration according to TAPPI/ANSI T 489 om-15.

17. The sheet of claim 1, wherein at least one layer comprises any of the resins selected from the group consisting of propylene-ethylene copolymer, Styrene-Ethylene-Butadiene-Styrene (SEBS), Styrene-Butadiene-Styrene (SBS), Styrene-[ethylene-(ethylene-propylene)]-Styrene block copolymer (SEEPS), Styrene-isoprene block copolymers (SIS), Thermoplastic Olefin (TPO), Thermoplastic Polyurethane (TPU), Melt Processible Rubbers (MPR), Co-polyester-Ether (COPE), and Polyether Block Amide (PEBA).

18. The sheet of claim 1, wherein at least one layer comprises any of the resins selected from the group consisting of polyethylene (PE), polypropylene (PP), polystyrene (PS), ethylene-vinyl acetate (EVA), ethylene vinyl alcohol (EVOH), polyvinyl chloride (PVC), Polyvinylidene chloride (PVDC), polyamide (PA), polyurethane (PU), or Maleic anhydride, or an ionomer.

19-27. (canceled)

28. An article comprising the sheet of claim 1.

29. (canceled)

30. A process of making the sheet of claim 1, comprising the inclusion of a physical blowing agent in a molten polymer to form a single-phase polymer/gas mixture in the coextrusion line, extruding the mixture through a die to form a sheet with a cellular structure, and post-forming and solidifying the extrudate between the cold rolls to form a foam sheet with a uniform thickness, and/or uniform base weight (gr/cm²), and/or uniform density across the web.

31-35. (canceled)
